(19) United States
(12) Patent Application Publication
(10) Pub. No.: US 2008/0218934 A1
(43) Pub. Date: Sep. 11, 2008

(54) Method of Manufacturing a Microsystem, Such a Microsystem, a Stack of Foils Comprising Such a Microsystem, an Electronic Device Comprising Such a Microsystem and Use of the Electronic Device

(75) Inventors: Geert Langereis, Eindhoven (NL); Johannes Wilhelmus Weekamp, Beek en Donk (NL); Jacobus Bernardus Giesbers, Son (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,774

(22) PCT Filed: Aug. 24, 2006
(86) PCT No.: PCT/IB2006/052946

§ 371 Date: Mar. 5, 2008

(30) Foreign Application Priority Data
Sep. 9, 2005 (EP) 05108280.8

(51) Int. Cl. H01G 7/00; B32B 37/30

(52) U.S. Cl. 361/283.1; 156/290

(57) ABSTRACT

The invention relates to a method of manufacturing a microsystem and further to such microsystem. With the method a microsystem can be manufactured by stacking pre-processed foils (10) having a conductive layer (11a, 11b) on at least one side. After stacking, the foils (10) are sealed, using pressure and heat. Finally the microsystems are separated from the stack (S). The pre-processing of the foils (preferably done by means of a laser beam) comprises a selection of the following steps: (A) leaving the foil intact, (B) locally removing the conductive layer, (C) removing the conductive layer and partially evaporating the foil (10), and (D) removing both the conductive layer as well as foil (10), thus making holes in the foil (10). In combination with said stacking, it is possible to create cavities, freely suspended cantilevers and membranes. This opens up the possibility of manufacturing various microsystems, like MEMS devices and microfluidic systems.

The invention relates to a method of manufacturing a microsystem provided with a space. The invention further relates to such a microsystem. The invention also relates to a stack of foils comprising such a microsystem according to the invention. The invention also relates to an electronic device comprising a microsystem according to the invention. The invention also relates to the use of such an electronic device.

Such a method and microsystem are known from the publication Ramadoss, R. et al., “Fabrication, Assembly, and Testing of RF MEMS Capacitive Switches Using Flexible Printed Circuit Technology.” IEEE Transactions on Advanced Packaging, Vol. 26, No. 3, August 2003, pp. 248-254. With the known method, a copper-clad substrate layer is provided. The copper cladding is polished so as to make it flatter. Following that, coplanar waveguides are defined in the copper cladding, using photolithography and etching steps. Then, a layer of polymer is applied to the substrate and subsequently patterned, which polymer forms the dielectric for the bottom electrode. Furthermore, a polyimide membrane is provided in the known method, on which a copper layer is formed. The copper layer is patterned, using photolithography and etching steps, thereby forming the top electrode. The polyimide membrane is patterned by means of a laser so as to form openings in the membrane. The method furthermore comprises a step in which an adhesive layer is provided for defining the spacing between the bottom electrode and the top electrode. With the known method, an MEMS switch is obtained by stacking the polyimide membrane on the substrate, albeit separated therefrom by the adhesive layer. The alignment of the various layers takes place by means of a fixation element comprising reference pins. Finally, the various layers are interconnected by exerting a pressure on the layers at an elevated temperature.

The problem with the known method is that it is a relatively complex method.

It is an object of the invention to provide a method of the kind referred to in the introduction which is less complex.

According to the invention, this object is achieved by a method of manufacturing a microsystem provided with a space, which method comprises the following steps:

providing a set of at least two electrically insulating flexible foils, wherein the individual foils comprise the same foil material, and wherein a conductive layer is present on at least one side of at least one foil, and wherein said conductive layer is suitable for use as an electrode or a conductor;

patterning the conductive layer so as to form an electrode or a conductor;

patterning at least one foil, in such a manner that an opening is formed, which opening forms the space of the microsystem;

stacking the set of foils, thus forming the microsystem; and

joining the foils together, with the foils being bonded together at those positions where, when two adjacent foils are in contact with each other, at least one conductive layer between the foil material of two adjacent foils has been removed.

Using the method according to the invention, a person skilled in the art will need only one kind of foil material, by means of which he will be able to form any microsystem. It has furthermore become possible to obtain the foils only from one and the same roll. With the known method, on the other hand, a different material must be selected for every layer. Consequently, the method according to the invention is less complex than the known method.

An additional advantage of the method according to the invention is the fact that it is a universal method. This means that the method is a modular method, and that it is suitable for more applications than the known method, therefore.

An improved embodiment of the method according to the invention is characterized in that a set of foils is provided, with the individual foils having substantially the same thickness. The advantage of this aspect is that a higher degree of regularity will be obtained than with the known method. For example, if layers or spaces having a thickness different from the thickness of one foil are to be realized in a device, a multitude of foils can be stacked together in a simple manner. A foil having a different thickness is not needed, therefore. All the dimensions in the direction perpendicular to the foils will thus at all times amount to a multitude of the thickness of one foil. In addition, it will suffice to use foil from one and the same roll when using this improved method. This renders the method even less complex and consequently even more inexpensive.

An additional advantage of using foils having a uniform thickness is the fact that it is possible to implement a device in any subset of foils in a stack comprising several foils. For example, if A is a pump to be designed comprising 5 layers of foil, and B is a sensor to be designed in a channel comprising 3 layers of foil, many different ways of placing the designs A and B in a stack of 30 layers of foil are available to the designer.

The method is preferably characterized in that at least three electrically insulating flexible foils are provided. This is advantageous in particular if more complex structures are to be formed, in which case two flexible foils do not suffice. Another embodiment of the method according to the invention is characterized in that at least four electrically insulating foils are provided. When at least four foils are used, more design possibilities are available to the designer. Thus, the designer may form a freely suspended flap, which functions as a shut-off valve of the space. Since two layers are present between the outer foils, there will be no adhesion at the position where the flap is adjacent to the space when the foils are being joined together, so that the flap will continue to be freely suspended. The flap can be opened or closed by means of a liquid flow, possibly also by means of electrostatic actuation.

One embodiment of the method according to the invention is characterized in that a movable element is formed of at least one foil in the microsystem, which movable element is attached to the microsystem on at least one side, wherein the movable element is selected from the group comprising a movable mass, a movable valve and a movable membrane, and wherein the movable element is present at one side of the space. Such an aspect makes it possible to form active microfluidic devices and MEMS devices. In the case of active microfluidic devices it is important to block the flow of a gas or a liquid in a particular direction and/or maintain the flow in another direction. In the case of MEMS devices, a conversion of a movement of one element into an electrical signal on an electrode is usually concerned or, quite the reverse, of an electrical signal on an electrode into a movement of an element.

Another embodiment of the method according to the invention is characterized in that the microsystem is provided with a sensor which is formed in a conductive layer on a foil near the space for measuring a quantity in said space. A sensor is likewise an important building block in MEMS devices and microfluidic devices.

A first main variant of the above embodiments of the method is characterized in that the microsystem to be manufactured comprises an MEMS device. A further elaboration of this main variant of the method is characterized in that the microsystem that is manufactured is a microsystem from the group comprising an MEMS capacitor microphone, an MEMS pressure sensor, an MEMS accelerometer. These devices are important building blocks in larger electronic devices, which can be produced in a relatively inexpensive manner by means of the method. Other devices are also possible, of course.

A second main variant of the above embodiments of the method is characterized in that the microsystem to be manufactured comprises a microfluidic device. A further elaboration of this main variant of the method is characterized in that the microsystem that is manufactured is a microsystem from the group comprising a microvalve, a micropump and a μTAS element. These devices are important building blocks in microfluidic devices, which can be produced in a relatively inexpensive manner by means of the method. Other devices are also possible, of course.

A further improved embodiment of the method according to the invention is characterized in that said patterning is carried out by means of a laser, whether or not in combination with a mask. This aspect makes it possible to realize a highly controlled removal of the conductive layer and/or the foil material. In addition, it is very advantageous that the space need not be cleared through selective etching of sacrificial materials, which is necessary when conventional methods are used.

A further improved embodiment of the method according to the invention is characterized in that said patterning is carried out by using a selection from the following steps:

leaving the conductive layer and the foil intact;

removing the conductive layer so as to expose the foil;

removing the conductive layer and part of the foil, so that a thinner foil remains; and

completely removing the conductive layer and the foil so as to form the space.

The above four basic steps provide essentially four main areas, which, when combined, can provide the desired pattern in the foils:

areas where both the foil and the conductive layer have not been removed,

areas where only the conductive layer has been removed (for example so as to form a connection with the adjacent foils),

areas where the conductive layer but also part of the foil has been removed ( for example so as to manipulate the flexibility of the foil), and

areas where both the conductive layer and the foil have been removed (for example so as to create a space).

An advantageous embodiment of the method according to the invention is obtained if said stacking of the foils takes place by winding at least one foil on a first reel. A major advantage of this embodiment is that aligning the foils will be easier when the foils are being stacked.

An improved embodiment of the latter method is characterized in that the method is carried out in a process in which the foil is unwound from a second reel or roll upon being wound onto the first reel. The major advantage of this aspect is that the method can be carried out in a continuous process, so that the method will be easier to automate.

A further improvement is obtained if said patterning of the conductive layer and the foil takes place at at least one position selected from the following possibilities: on or near the first reel, between the first and the second reel, and on or near the second reel or roll. Depending on the question whether a conductive layer is present on both sides of the foil, a person skilled in the art can choose where he wants said patterning to take place.

The method according to the invention is preferably characterized in that said joining of the foils is carried out by exerting a pressure on the stacked foils at an elevated temperature, with the pressure being exerted in a direction perpendicular to the foils. As a result, the foils will fuse together and the device will take its definitive shape.

A further elaborated embodiment of the latter method is characterized in that the required pressure on the foils adjacent to the space in the structure is obtained through the application of an elevated pressure in said space. The advantage of this aspect is that foils are pressed into better abutment with adjacent foils at places where they are adjacent to a space, so that a better adhesion of said foils will be obtained.

A preferred embodiment of the method according to the invention is characterized in that an opening is formed in the stack of foils so as to provide access from one side of the microsystem to a conductive layer that is connected to an electrode of the microsystem. In this way a contact area is provided, as it were, for electrically connecting the electrode.

A further elaborated embodiment of the method according to the invention is characterized in that the microsystem is separated from the stack after fusion of the foils has taken place. The separate device thus obtained has this advantage that it can be traded or be incorporated in a product.

Another embodiment of the method according to the invention is characterized in that the material for the conductive layer is selected from the group comprising aluminum, platinum, silver, gold, copper, indium tin oxide, and magnetic materials. These materials are very suitable for use as electrodes and/or conductors. Indium tin oxide moreover has the advantage of being optically transparent, which is advantageous when used in microfluidic devices.

The method according to the invention is preferably characterized in that the foil material is selected from the group comprising polyphenyl sulphide (PPS) and polyethylene terephthalate (PET). These materials are quite suitable for use as an electrically insulating foil material.

A preferred embodiment of the method is characterized in that the foil that is used has a thickness between 1 μm and 5 μm. The advantage of using a foil thickness in that range is that a reasonable degree of flexibility of the foils is obtained, as well as a reasonable degree of accuracy with which the dimensions in the device in a direction perpendicular to the foils can be fixed.

The invention further relates to a microsystem built up of a set of at least two electrically insulating flexible foils stacked one on top of the other, wherein the individual foils comprise the same foil material, wherein at least one foil is provided with a patterned conductive layer, which is arranged as an electrode, and wherein at least one foil is provided with a space. The advantage of the microsystem according to the invention is that less torsional forces (for example due to temperature effects) will be generated upon stacking of the set of foils, because the layers have the same properties.

An improved embodiment of the microsystem according to the invention is characterized in that the individual foils have substantially the same thickness. A major advantage of this aspect is that the microsystem exhibits a greater degree of regularity than the known microsystem. All the dimensions in the direction perpendicular to the foils are a multitude of the thickness of one foil at all times. Consequently, the microsystem is less complex and thus less expensive.

A further improvement to the above embodiments of the microsystem according to the invention is characterized in that the microsystem comprises at least three electrically insulating flexible foils. This is advantageous in particular in the case of microsystems having a more complex structure, which cannot be realized by means of two flexible foils. Another embodiment of the method according to the invention is characterized in that it comprises at least four electrically insulating foils. A greater number of different Microsystems can be obtained when at least four foils are used. Thus, the microsystem may comprise a freely suspended flap, for example, which functions as a shut-off valve of the space. When the flap is positioned adjacent to the space, it will be freely suspended in part. The flap can be opened or closed by means of a liquid flow, or possibly by means of electrostatic actuation.

One embodiment of the microsystem according to the invention is characterized in that the microsystem comprises a movable element, which movable element comprises at least one foil and which is attached to the microsystem on at least one side, wherein the movable element has been selected from the group comprising a movable mass, a movable valve and a movable membrane, and wherein the movable element present at one side of the space. Such a movable element is required in active microfluidic devices and MEMS devices. In the case of active microfluidic devices it is important to block the flow of a gas or a liquid in a particular direction and/or to start the flow in another direction. In the case of MEMS devices, usually a conversion of a movement of an element into an electrical signal on an electrode is concerned, or, quite the reverse, of an electrical signal on an electrode into a movement of an element.

One embodiment of the microsystem according to the invention is characterized in that it is provided with a sensor which is implemented in a conductive layer on a foil near the space for measuring a quantity in said space. A sensor is likewise an important building block in MEMS devices and microfluidic devices.

One embodiment of the method according to the invention is characterized in that the microsystem comprises an MEMS capacitor microphone. Such an MEMS capacitor microphone is cheaper than a conventional MEMS capacitor microphone in silicon technology. An additional advantage is that it exhibits an improved electrical operation in comparison with a conventional MEMS capacitor microphone. After all, the foil material is electrically insulating (unlike a silicon substrate used with conventional MEMS capacitor microphones), so that there will be less parasitic capacitance.

A further elaborated embodiment of this microsystem is characterized in that the set of foils comprises at least three foils, with a space being present in the microsystem, which space is provided on a first side thereof with a first foil arranged as a membrane for receiving sound waves, and which space is provided on a second side thereof with a second foil arranged as a backplate, which second foil comprises an opening for the passage of pressure waves to a free space, which space has a thickness, measured in a direction perpendicular to the foils, of at least one foil, which microsystem is further characterized in that the membrane and the backplate are also provided with a conductive layer, which layers lead to areas for electrically connecting the microsystem. Such a design of the microsystem is attractive because of its simplicity. A major advantage of this design is that the surface area of the membrane can be just as large as that of the backplate. This in contrast to a microsystem in silicon technology, in which anisotropic etching of the space is required, with sloping being formed (said slope being 54.7°, for example, if said etching is carried out by means of a KOH solution in a <100> silicon wafer). Such solutions in silicon technology are known from, among other publications, the publication by Udo Klein, Matthias Müillenborn and Primin Romback, “The advent of silicon microphones in high-volume applications”, MST news 02/1, pp. 40-41.

A very attractive variant of the latter embodiment of the microsystem is characterized in that the foil of the membrane or the backplate is provided with a conductive layer on two sides. The advantage of this is that the presence of a conductive layer on two sides of the foil of the membrane or the backplate prevents possible warping of the foil.

Another improvement of said microsystem is obtained if the foil of the membrane comprises areas at the edges thereof which are thinner than the rest of the foil of the membrane. The advantage of this aspect is that it leads to an improved deflection profile of the membrane. Such an aspect is very difficult to realize in silicon technology, whereas it is fairly simple to realize in foil technology through partial removal of the foil (for example by means of a laser).

Another embodiment of the microsystem according to the invention is characterized in that it comprises an MEMS pressure sensor. Such an MEMS pressure sensor is cheaper than conventional MEMS pressure sensors in silicon technology. An additional advantage is that such an MEMS pressure sensor exhibits an improved electrical operation in comparison with conventional MEMS pressure sensors. After all, the foil material is electrically insulating (in contrast to a silicon substrate as used with conventional MEMS capacitor microphones), so that there will be less parasitic capacitance.

A further elaborated embodiment of this microsystem is characterized in that the set of foils comprises at least three foils, with a first space being present in the microsystem, which space is provided on a first side thereof with a movable membrane comprising a conductive layer that functions as a first electrode, which membrane, on the other side thereof, is positioned adjacent to a further space in which the pressure to be measured prevails, wherein the first space is provided on a second side thereof with a second electrode which is implemented in a conductive layer on a foil, wherein said first electrode and said second electrode overlap when projected on a plane parallel to the foils, so that the first electrode and the second electrode jointly form a capacitance that depends on pressure differences between said first space and said further space, causing the membrane to deflect, which microsystem is further characterized in that the first space has a thickness, measured in a direction perpendicular to the foils, of at least one foil, and which microsystem is further characterized in that the conductive layers of the electrode lead to areas for electrically connecting the microsystem. Such a design of the microsystem is attractive because of its simplicity.

Another embodiment of the microsystem according to the invention is characterized in that it comprises an MEMS accelerometer. Such an MEMS accelerometer is cheaper than a conventional MEMS accelerometer in silicon technology. An additional advantage is that such an MEMS accelerometer exhibits an improved electrical operation in comparison with conventional MEMS accelerometers. After all, the foil material is electrically insulating ( unlike a silicon substrate used with conventional MEMS accelerometers), so that there will be less parasitic capacitance.

A further elaborated embodiment of this microsystem is characterized in that the set comprises at least three foils, with a space having a thickness of at least one foil being present in the microsystem, which space is provided on a first side thereof with a first electrode on a movable mass, which mass is made up of a stack comprising at least one foil, and which mass is connected to the microsystem via resilient connections, and wherein a second electrode is present on an opposite side of the space, wherein both said first electrode and said second electrode are implemented in the conductive layer of or foil, wherein the first electrode and the second electrode overlap when projected on a plane parallel to the foils, so that said first electrode and said second electrode jointly form a capacitance, which capacitance depends on acceleration forces being exerted on the movable mass, which acceleration forces effect a relative movement of the mass with respect to the microsystem, and thus a change in the thickness of the space between the two electrodes, said microsystem further being characterized in that the conductive layers of the electrodes lead to areas for electrically connecting the microsystem. Such a design of the microsystem is attractive because of its simplicity. The resilient connections can be realized in a simple manner, for example in the form of thinned foils ( in which case the conductive layer has been fully removed and the foil material has been partially removed, therefore). It is also possible to remove the entire foil locally and leave only a few strips of foil functioning as resilient connections. Furthermore, a capacitive parallel plate configuration is used in this embodiment.

Another embodiment of the microsystem according to the invention is characterized in that it comprises a microvalve. Such a microvalve can be used in microfluidic systems and is cheaper than conventional microvalves in silicon technology. An additional advantage is that it works better than conventional microvalves. The valve is more flexible than conventional microvalves made in silicon technology. An additional advantage of this microvalve is the fact that it is optically transparent (provided that the conductive layer has been removed). This makes it possible to use optical detection methods and carry out optical inspections. This is not possible with microvalves in silicon technology.

A further elaborated embodiment of this microsystem is characterized in that the set of foils comprises at least four foils, with a space having an inlet and an outlet being present in the microsystem, wherein at least the outlet can be shut off by means of a movable valve that is attached to the microsystem, said valve comprising a foil provided with a conductive layer that defines a first electrode, and wherein the space is provided on a first side thereof with a second electrode and, on an opposite side, with a third electrode, wherein both said second electrode and said third electrode are implemented in an electrically conductive layer on a foil, wherein all the electrodes overlap when projected on a plane parallel to the foils, so that said second electrode and said third electrode can be used for driving the movable valve capacitively, which microsystem is further characterized in that the space has a thickness of at least one foil, measured in a direction perpendicular to the foils, said microsystem further being characterized in that the conductive layers of the electrodes lead to areas for electrically connecting the microsystem. Such a design of the microsystem is attractive because of its simplicity. In this embodiment, the movable valve may be a cantilever valve, because it is adjacent to the space and thus does not locally experience a sufficiently elevated pressure during the manufacturing step of fusing the foils at a high temperature and an elevated pressure on the foil stack, so that it will not bond to the underlying foil.

Another embodiment of the microsystem according to the invention is characterized in that it comprises a micropump. Such a micropump can be used in microfluidic systems and is cheaper than conventional micropumps in silicon technology. An additional advantage is that such a micropump exhibits an improved operation in comparison with conventional micropumps. The valve is more flexible than the valves used with conventional micropumps made in silicon technology. Another additional advantage of this micropump is that it is optically transparent (provided that the conductive layer has been removed). This makes it possible to use optical detection methods and carry out optical inspections. This is not possible with a micropump in silicon technology.

A further elaborated embodiment of this microsystem is characterized in that the set comprises at least six foils, with a first space having an inlet and outlet being present in the microsystem, wherein both the inlet and the outlet can be shut off by means of a movable valve comprising a foil that is attached to the microsystem, and wherein said first space is provided on a first side thereof with a movable membrane comprising an electrically conductive layer that defines a first electrode, which movable membrane is positioned adjacent to a second space at an opposite side thereof, which second space is provided on an opposite side thereof with a foil comprising an electrically conductive layer that functions as a second electrode and, wherein said first electrode and said second electrode overlap when projected on a plane parallel to the foils, so that the second electrode can be used for driving the movable membrane capacitively, which microsystem is further characterized in that the two spaces have a thickness of at least one foil, measured in a direction perpendicular to the foils, said microsystem further being characterized in that the conductive layers of the electrodes lead to areas for electrically connecting the microsystem. Such a design of the microsystem is attractive because of its simplicity. The membrane can be set moving in various ways. In the first place this can be done by electrostatic means. In that case a voltage on the second electrode relative to the first electrode in the membrane will cause the membrane comprising the first electrode to move in the direction of the second electrode, as a result of which the second space will decrease in volume and the first space will increase in volume, thereby generating an underpressure in the latter space, so that liquid or gas can be sucked in via the inlet. The movable valve at the inlet will open under the influence of the pressure difference in that case. In the second place, resistive heating may be used. In that case an electrode is configured so that an electrical resistor is formed. The passage of an electrical current through said resistor will cause the resistor to heat up, thereby heating the environment. When the resistor is placed in a space that is screened by a flexible membrane, said heating of the volume will cause the membrane to bulge. As a result, a second space will decrease in volume and the first space will increase in volume, thereby generating an underpressure in said space, so that liquid or gas can be sucked in via the inlet. The movable valve at the inlet will open under the influence of the pressure difference in that case.

The latter embodiment is preferably characterized in that the microsystem is furthermore provided with another conductive layer on the foil on a second side of the first space, which conductive layer defines a third electrode, wherein said first electrode and said third electrode overlap when projected on a plane parallel to the foils, so that the third electrode can also be used for driving the movable foil capacitively, said microsystem further being characterized in that the conductive layer of this electrode also leads to an area for electrically connecting the microsystem. The advantage of the third electrode is that it can also be used for driving the membrane electrically. For example, if a voltage is applied to the third electrode relative to the first electrode, the polarity of which voltage is opposed to that of the voltage on the first electrode, the membrane is pushed away from the third electrode, as it were. This makes it easier to move the membrane, since the electrical forces are greater.

A possible embodiment of the microsystem according to the invention is characterized in that it comprises a μTAS element. Such a μTAS element can be used in microfluidic systems, it is cheaper than conventional μTAS elements in silicon technology. An additional advantage of this μTAS element is that it is optically transparent (provided that the conductive layer has been removed). This makes it possible to use optical detection methods and carry out optical inspections. This is not possible with a μTAS element in silicon technology. Other additional advantages of such a μTAS element are:

the foils bond well, so that there is less chance of leakage;

the foils are hydrophobic, so that no residues of liquids will remain behind in the μTAS element, with this advantage that no hydrophobic coatings are required, as is the case, for example, with μTAS elements in silicon technology; and

the element is biocompatible.

A further elaborated embodiment of this microsystem is characterized in that the set comprises at least three foils, with a channel having an inlet and an outlet for the passage of a gas or a liquid therethrough being present in the microsystem, wherein the channel has a thickness of at least one foil, measured in a direction perpendicular to the foils, and wherein the channel is provided with a sensor or actuator on one side thereof. Such a design of the microsystem is attractive because of its simplicity.

Preferably, the latter embodiment is characterized in that said sensor or actuator is formed in the conductive layer of the foil adjacent to the channel.

A first variant of these embodiments is characterized in that it comprises a flow sensor. A second variant of these embodiments is characterized in that it comprises a conductivity sensor. Implementation of such sensors makes it possible to measure quantities such as flow rate, temperature, conductivity etc. in the space.

A further improvement of the latter two embodiments is characterized in that it comprises a further sensor or actuator, which is present in a conductive layer of the foil adjacent to an opposite side of the channel. This embodiment thus comprises sensor structures both on the bottom of the channel and at the upper side of the channel. The fact is that foils may be provided with a conductive layer on two sides thereof. This is something that is practically impossible in silicon technology. In this embodiment a designer can dispose a heating element opposite a conductivity sensor, for example. Heating and measuring is a sensor-actuator combination that may provide useful information on the liquid.

Preferably, the microsystem according to the invention is characterized in that the material of the conductive layer comprises a metal from the group comprising aluminum, platinum, silver, gold, copper, indium tin oxide, and magnetic materials. The selection of a material from this group is partially determined by the requirements that are made of the micro system.

Preferably, in the microsystem according to the invention is characterized in that the material for the foils comprises a substance from the group comprising polyphenyl sulphide (PPS) and polyethylene terephthalate (PET).

Preferably, the microsystem according to the invention is characterized in that the foil has a thickness between 1 μm and 5 μm.

The invention also relates to a stack of foils comprising a device according to the invention. The stack may also be in the form of a foil that is wound on a reel.

The invention also relates to an electronic device comprising the MEMS device according to the invention. One embodiment of the electronic device is characterized in that it furthermore comprises an integrated circuit for reading or driving a signal from the micro system.

A very advantageous embodiment of the electronic device according to the invention is characterized in that the microsystem is provided with a recess, in which the integrated circuit is accommodated, so that the microsystem in fact forms part of the package of the integrated circuit, which integrated circuit is connected to the microsystem. Because of this aspect, the integrated circuit does not require a traditional package, as a result of which it is less complex and also cheaper. Moreover, the provision of an integrated circuit in this manner has an advantageous effect on the electrical operation of the microsystem. The spacing between the microsystem and the integrated circuit remains relatively small, so that the occurrence of capacitive and inductive interference in the connections between the microsystem and the integrated circuit is reduced.

The invention also relates to the use of such an electronic device, characterized in that the microsystem comprises an MEMS capacitor microphone for recording sound, wherein the MEMS capacitor microphone delivers a voltage X on electrodes and wherein the voltage X is read by the integrated circuit. The user will experience less noise when using such an electronic device.

The above and further aspects of the method and the device according to the invention will now be explained in more detail with reference to the figures, in which:

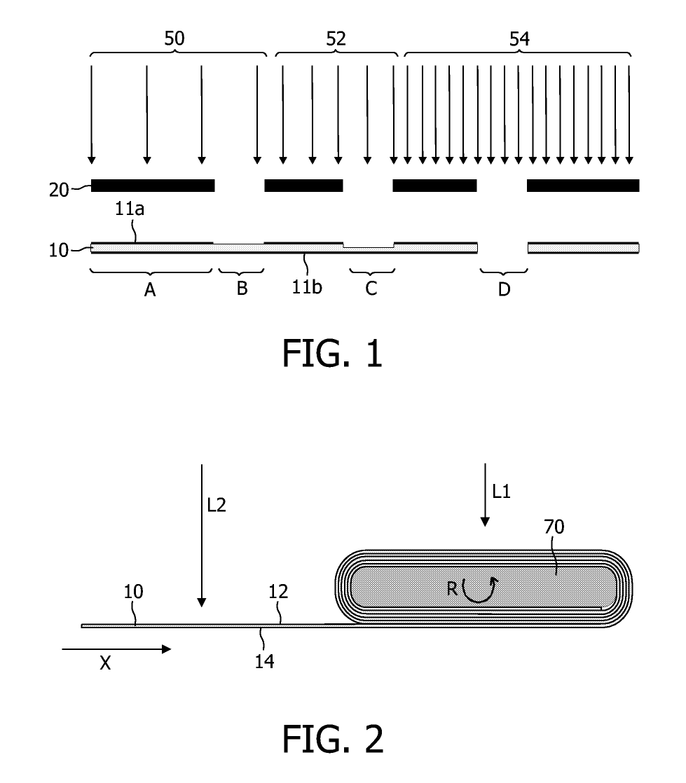

FIG. 1 is a schematic representation of a part of the method, which shows the manner in which four different areas are created on a foil with a conductive layer present thereon;

FIG. 2 shows the manner in which foils can be automatically aligned and also patterned;

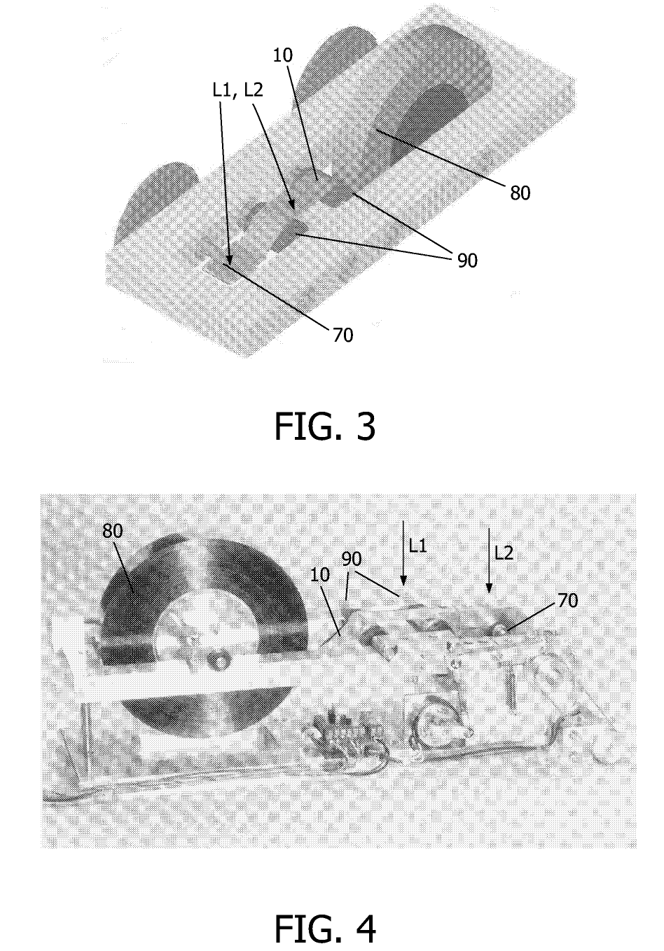

FIG. 3 is a schematic representation of an embodiment of a part of an arrangement for carrying out the method according to the invention;

FIG. 4 shows a photo of an actual arrangement for carrying out the method;

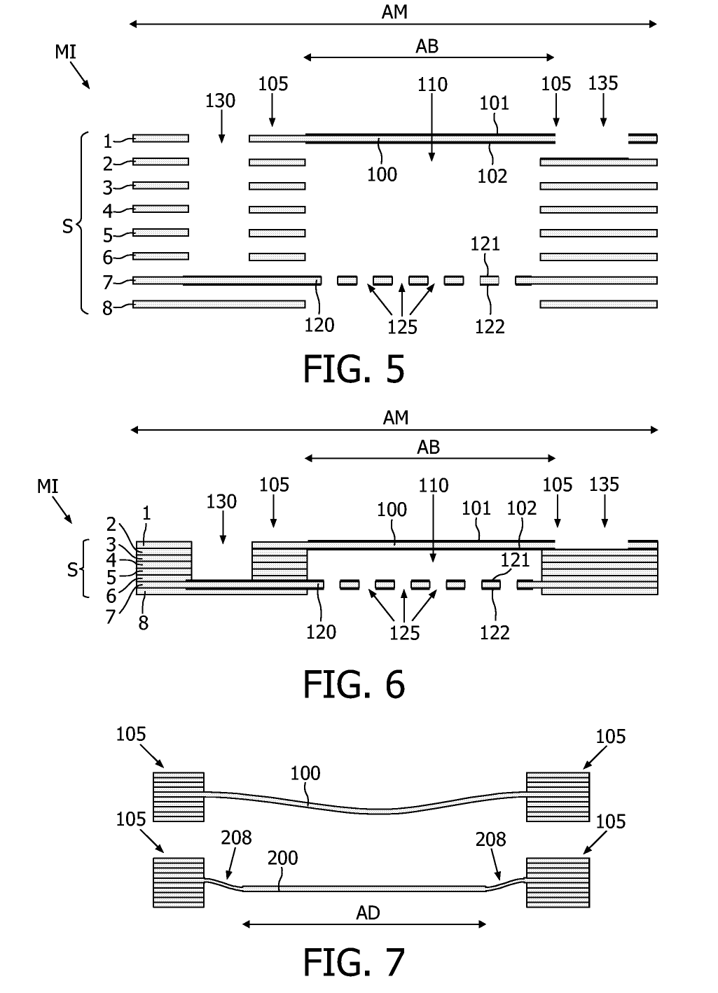

FIG. 5 shows a stack of eight foils forming an MEMS capacitor microphone structure;

FIG. 6 shows a first embodiment of the microsystem according to the invention, viz. an MEMS capacitor microphone, after bonding of the foils of FIG. 5;

FIG. 7 shows a membrane of an MEMS capacitor microphone which has been thinned in certain places in accordance with one aspect of the method according to the invention;

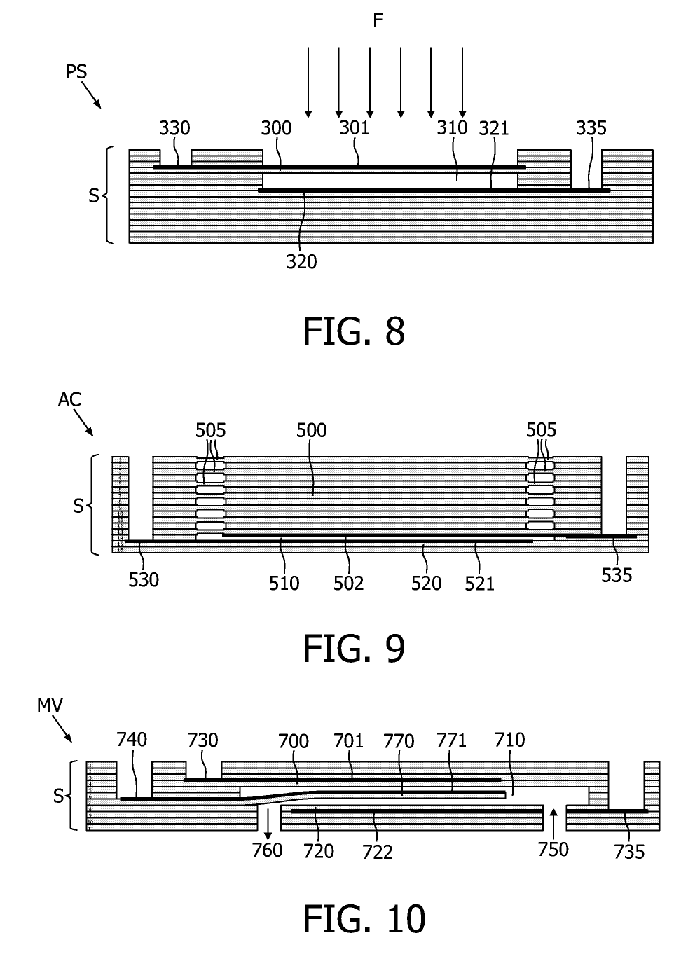

FIG. 8 shows a second embodiment of the microsystem according to the invention, viz. an MEMS pressure sensor;

FIG. 9 shows a third embodiment of the microsystem according to the invention, viz. an MEMS accelerometer;

FIG. 10 shows a fourth embodiment of the microsystem according to the invention, viz. an electrostatically driven microvalve;

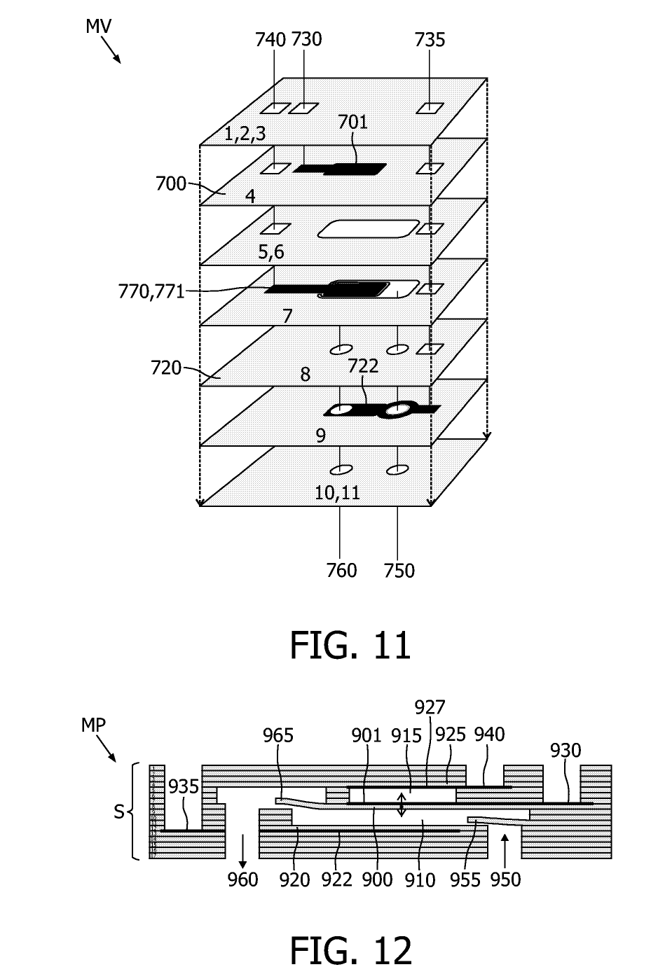

FIG. 11 is an expanded 3-dimensional illustration of the electrostatically driven microvalve of FIG. 10;

FIG. 12 shows a fifth embodiment of the microsystem according to the invention, viz. an electrostatically driven micropump;

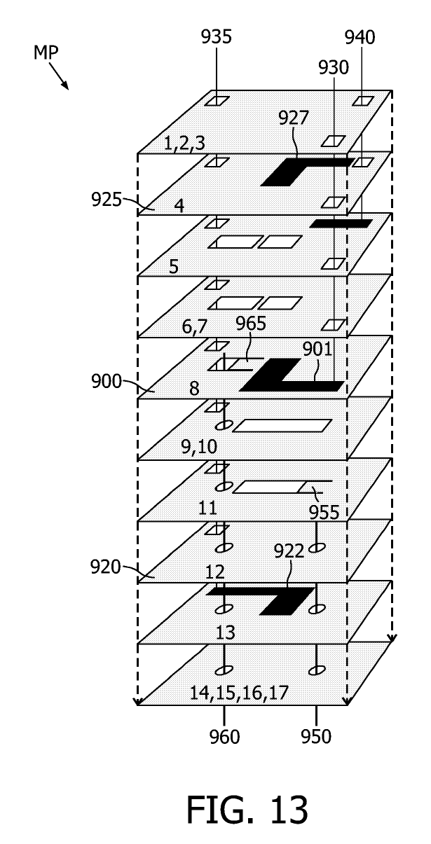

FIG. 13 is an expanded 3-dimensional illustration of the electrostatically driven microvalve of FIG. 12;

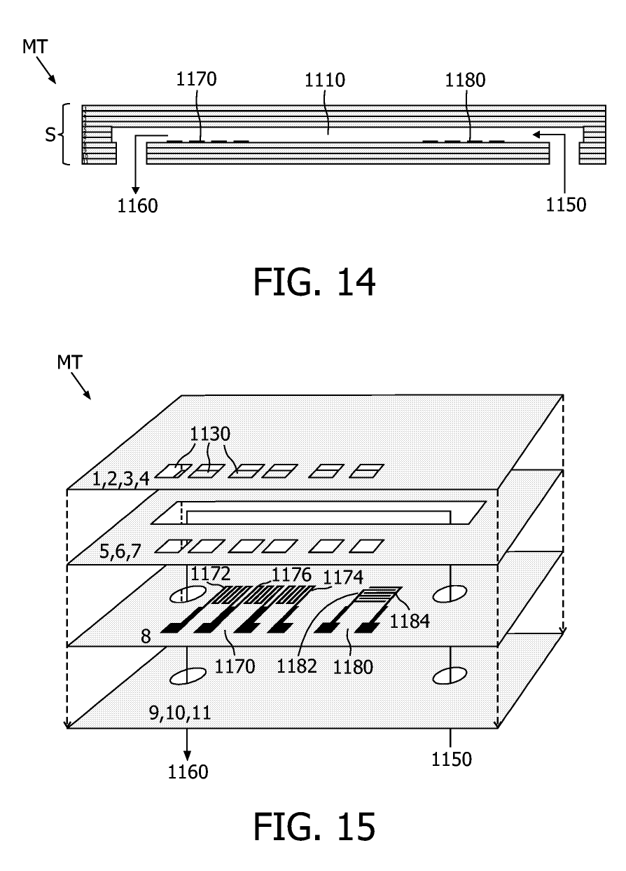

FIG. 14 shows a sixth embodiment of the microsystem according to the invention, viz. a μTAS element;

FIG. 15 is an expanded 3-dimensional illustration of the μTAS element of FIG. 14;

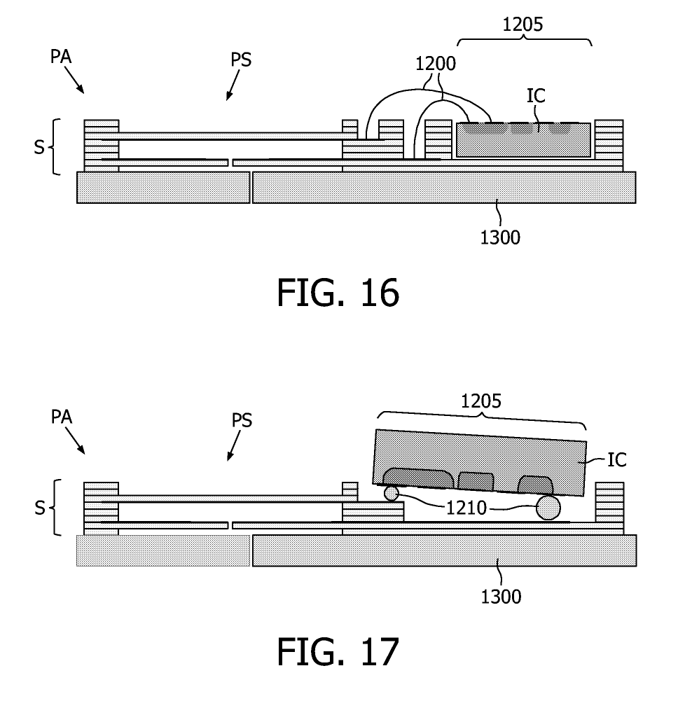

FIG. 16 shows an MEMS pressure sensor which also functions as part of a package of an integrated circuit, in which soldering wires are used for the connections between the MEMS pressure sensor and the integrated circuit;

FIG. 17 shows an MEMS pressure sensor which also functions as part of a package of an integrated circuit, in which flip-chip technology is used.

Hereinafter a detailed description of the invention will be given. As already said before, the invention relates both to a method of manufacturing a microsystem and to such a microsystem itself. A great many embodiments of the microsystem according to the invention are possible, which embodiments are of a diverse nature. Nevertheless, all these embodiments have a common factor, viz. the fact that they are built up of a joined-together stack of pre-processed electrically insulating foils that are provided with a conductive layer on at least one side thereof.

The method of producing the microsystem comprises several substeps:

applying a conductive layer to at least one side of the foils (two sides is also possible, therefore, and is even preferable in some cases);

pre-processing the foils;

stacking the foils, thus forming the microsystem;

bonding the foils; and

separating the microsystem from the stack of foils.

Said pre-processing of the foils consists of a selection of the following steps:

leaving the conductive layer and the foil intact;

removing the conductive layer so as to expose the foil;

removing the conductive layer and part of the foil, so that a thinner foil remains; or

completely removing the conductive layer and the foil.

The combination of the above steps makes it possible to realize a large number of different patterns both in the conductive layer and in the foil, which enables a designer to create many different structures. Preferably, the removal of the material in the above steps is carried out by means of a laser (for example an excimer laser). A major advantage of using a laser is that said removal can take place outside a clean room, in contrast to removal by etching, for example. Several possibilities are open to a person skilled in the art in this connection. A person skilled in the art may use a wide parallel laser beam in combination with a mask, or he can scan the surface of the foil with a single laser beam and at the same time modulate the intensity of the beam. In that case a person skilled in the art can choose again between modulating either the intensity or the duty cycle of a series of brief light pulses.

FIG. 1 shows the manner in which said pre-processing by means of a collimated laser beam and a mask is carried out. The figure shows three laser beams 50, 52, 54, each having a different intensity (running up from the left to the right in this example). The mask 20 partially stops the laser beams 50, 52, 54. Present below the mask 20 is the foil 10, which is provided with a conductive layer 11a, 11b on both sides in this example. It is also possible to use only one conductive layer 11a, of course. Preferably, the conductive layers 11a, 11b comprise aluminum, platinum, silver, gold, copper, indium tin oxide or magnetic materials.

In area A the mask 20 screens the foil 10, so that the low-energy beam 50 cannot reach the foil 10. The foil 10 remains unaffected. In area B the laser beam 50 does reach the foil, but the energy of the laser beam 50 is such that only the conductive layer 1 la is removed (and possibly also a thin layer of the foil material, but in any case only to a negligible extent). When the energy level is further increased, a substantial part of the foil material 10 will be removed as well, so that an area C comprising a thinner foil is created. Finally, holes can be formed and the foil 10 by means of a high-energy laser beam 54. Such a hole is shown at the area D in the figure. In the foregoing, mention is made of increasing the energy level of the laser beam, which can be understood to mean that either the intensity or the duration of the laser pulse is increased. After all, the only thing that matters is that the extent to which the material is removed depends only on the amount of energy that is applied. Manipulating the duty cycle of a pulsed laser beam is easier than manipulating the light intensity of a laser beam for that matter.

After the foils 10 have been pre-processed, stacking can take place. Preferably, this is done by winding a foil onto a reel. Such an arrangement is shown in FIG. 2. The pre-processed foils 10 are in fact contained in one and the same tape in that case. When the foil material consists of Mylar, this is available inter alia in the form of a rolled-up tape having a thickness of 1 μm and a width of 2 cm. Said foil is also available with a 20 nm thick layer of aluminum present thereon (on one side or on both sides), which layer is suitable for use as the conductive layer in Microsystems. In the present description, however, only separate foils 10 will be discussed. In this arrangement both the front side and the rear side of the foil 10 can be pre-processed. Also in this case, this may be done by means of a laser beam, for example at positions L1, L2. The foil 10 moves in the direction X during said winding, being wound onto a reel 70, which has two flat sides in this example, in the direction of rotation R. A first laser beam at position L1 is directed at the foil that is present on the reel 70, so as to pre-process the foil 10 at the rear side 14 of the foil 10. A second laser beam at position L2 is directed at the foil that is not present on the reel 70 yet, so as to pre-process the foil 10 at the front side of the foil 10. It is not essential that the foil 10 be provided with a conductive layer on both sides 12, 14, and consequently it is not essential that the foil 10 be pre-processed on two sides 12, 14, either. In some applications it may be useful, however, as will become apparent in the discussion of some of the embodiments of the microsystem hereinafter.

A major advantage of winding a foil 10 onto a reel 70 is that this makes it much easier to align the foils 10. The stacking of preprocessed foils 10 (which may or may not be done by winding the foils onto a reel 70) makes it possible to create spaces, cantilevers and membranes. Elements of this kind are usually required in Microsystems such as MEMS devices and microfluidic devices.

After the foils 10 have been stacked, they can be bonded together, using an elevated pressure and an elevated temperature. When foils 10 are stacked by being wound onto a reel 70, said bonding can simply take place while the foils 10 are being wound onto the reel. In fact there are three possibilities when bonding a stack of foils:

the foil material of one foil makes direct contact with the foil material of the other foil, resulting in a strong bond;

the foil material of one foil makes direct contact with the conductive layer of the other foil, resulting in a weak bond;

the conductive layer of one foil makes direct contact with the conductive layer of the other foil, in which case a bond is not obtained.

If no pressure is exerted, the foils 10 will not bond together. This effect can be utilized for making valves. In particular when of foil 10 is adjacent to a space, it will not experience any pressure because of the flexibility of the foils. In fact the foil 10 will continue to be freely suspended. This aspect will come up again in the discussion of embodiments of the microsystem according to the invention hereinafter.

When it is nevertheless desirable that foils adjacent to a space be bonded, this can be achieved by using an elevated pressure in said space, for example. Said pressure may be a gas pressure but also a liquid pressure.

FIG. 3 is a schematic representation of an embodiment of a part of a possible arrangement for carrying out the method. FIG. 4 shows a photograph of an actual arrangement for carrying out the method. In the arrangement as shown, the foil 10 is unwound from a reel 80 and at the same time wound onto the aforesaid reel 70 via auxiliary rollers 90. The figure furthermore shows the possible positions of the laser beams L1, L2.

FIG. 5 and FIG. 6 show a first embodiment of the microsystem according to the invention. Both figures illustrate an MEMS capacitor microphone MI, which is built up of a stack S of preprocessed foils. In FIG. 5, the MEMS microphone MI is shown in expanded form prior to the bonding of the foils. In FIG. 6 the foils are bonded together. The foil stack S may be placed on the substrate so as to make the whole more manageable. The MEMS microphone MI comprises a movable membrane 100 adjacent to a space 110, which is anchored in several areas 105. In the sectional views of the figure, said areas appear to be separated, but preferably said area 105 completely surrounds the space 110.

The membrane is provided with a conductive layer on both sides 101, 102. In fact only one conductive layer is needed on one side (in this example the bottom side 102) for forming an electrode in the membrane 100, but the advantage of using a second conductive layer on the other side 101 is that warping of the membrane 100 will occur less easily. Present within the space, spaced from the membrane 100 by some distance, is a backplate 120, which is likewise provided with a conductive layer on both sides 121, 122. In fact only one conductive layer is needed on one side (in this example the upper side 121) for forming an electrode in the backplate 120, but also in this case the advantage of using a second conductive layer on the other side 122 is that warping of the backplate 120 will occur less easily. The electrodes of the membrane 100 and the backplate 120 jointly form a capacitor. The spacing between the capacitor plates amounts to five foils in this example. When foils having a thickness of 1 μm are used, the spacing will amount to 5 μm. If the MEMS microphone MI has a surface area AM of 2×2 mm², the surface area AB of the membrane 100 may come close to said value (the dimensions are not to scale in the drawing). In other words, the surface area in the MEMS microphone MI according to the invention can be utilized more efficiently than with the known MEMS microphones, such as the MEMS microphone that is known from the publication by Udo Klein, Matthias Müllenborn and Priming Romback “The advent of silicon microphones in high-volume applications”, MSTnews 02/1, pp. 40-41. When the Mylar tape having a width of 2 cm is used, it is possible to produce ten MEMS microphones alongside each other in an almost infinite number of rows (determined only by the length of tape on the reel).

The backplate 120 is preferably provided with openings 125 for releasing differences in air pressure that arise in the space 110 during vibration of the membrane 100 induced by sound waves. The operation of the MEMS microphone is as follows. Sound waves set the membrane 100 in motion (the membrane will start to oscillate). As a result, the spacing between the membrane 100 and the backplate 120 will start to oscillate as well, which in turn leads to oscillation of the capacitance of the capacitor (formed by the conductive layers on the membrane 100 and the backplate 120). These capacitance changes can be electrically measured and are at the same time a measure of the sound waves on the membrane 100.

The MEMS microphone MI is provided with contact holes 130, 135 that function to provide access to the capacitor plates (electrodes) of the membrane 100 and the backplate 120. The upper electrode on the membrane 100 is positioned partially on foil 1 and partially on foil 2. In this way the electrode will become accessible from the upper side via the contact hole 135.

In the example of FIG. 5 and FIG. 6, the MEMS microphone MI comprises a stack S of eight foils 1, 2, 3, 4, 5, 6, 7, 8. A different number of foils is also possible, however. This depends in particular on the desired vertical dimensions and spacing values of the microphone. The same applies to all the embodiments of the microsystem according to the invention that are discussed in the present description.

In case the tensile stress of the membrane 100 is not sufficient, as a result of which the deflection profile of the membrane is not optimal, the designer may elect to make the membrane 100 thinner at the edges. This is shown in FIG. 7. Both membranes 100 are anchored in areas 105. The upper membrane 100 in the figure does not comprise any thinned areas and deflects most strongly in the center on account of the sound pressure. The lower membrane 200 in the figure, on the other hand, does comprise thinned areas 208 at the edge, as a result of which the membrane 200 exhibits the same extent of the deflection over a relatively large area AD. The consequence of this aspect is that a larger electrical signal on the capacitor (made up of the conductive layers on the membrane 100 and the backplate 120) of the MEMS microphone MI can be measured with the same sound pressure. The forming of such thinned areas 208, using the method according to the invention, is fairly simple for that matter (partial removal of the foil, for example by means of a laser), whereas this is very difficult in silicon technology.

FIG. 8 shows a second embodiment of the microsystem according to the invention. This figure shows an MEMS pressure sensor PS built up of a stack S of preprocessed foils. In fact, such a pressure sensor PS is a special microphone. It exhibits a great deal of resemblance with the MEMS microphone MI, therefore. The MEMS pressure sensor PS comprises a movable membrane 300, which closes a space 310 in the MEMS pressure sensor. At the upper side 301, the membrane is provided with a conductive layer for forming an electrode. Present at the other side of the space 310 is a second electrode 321 in the form of a conductive layer on a closed backplate 320. This is at the same time the characteristic difference with the microphone, the space of the MEMS pressure sensor PS is closed and the space of the MEMS microphone MI is in communication with the surrounding atmosphere.

In this example, the backplate 320 comprises several foils. The advantage of this is that the backplate 320 will be relatively rigid in comparison with the movable membrane 300. The number of foils may vary, however. The designer has freedom of choice in selecting this number. For example, if the designer elects to place the foil stack S on a substrate, the number of foils for the backplate 320 can be reduced.

The operation of the MEMS pressure sensor is as follows. A force F on the membrane 300 (which is a measure of the pressure difference between the space 310 and the free space above the membrane 300) will cause the membrane to deflect. This causes the spacing between the membrane 300 and the backplate 322 change, as a result of which the capacitance of the capacitor (formed by the conductive layers on the membrane 300 and the backplate 320) will change as well. This capacitance change can be electrically measured and is at the same time a measure of the force F on the membrane 300 (and thus the pressure).

The MEMS pressure sensor PS is provided with contact holes 330, 335 that function to provide access to the capacitor plates (electrodes) of the membrane 300 and the backplate 320.

FIG. 9 shows a third embodiment of the microsystem according to the invention. This figure shows an MEMS accelerometer AC built up of a stack S of preprocessed foils. An accelerometer can be made up of a seismic mass 500 on a resilient element 505. The movement of the mass 500 can be measured as a change in the capacitance of parallel plates 505, 521 with a space 510 present therebetween. A possible embodiment is shown in FIG. 9. It is not possible to separate a piece of foil completely from the remaining foil during manufacture of the MEMS accelerometer AC (especially during the preprocessing of the foils while they are still contained in the tape). A solution is to use thin anchors in all foil layers of the seismic mass 500 in the form of locally thinned portions 505 in the foil. In this example, the mass 500 is made up of the foils 1-13. The foils will bond poorly during manufacture, because of the presence of the space 510 (a bond is not obtained if no pressure is applied). A solution is to implement the conductive layers on both sides of the space 510, in such a manner that they are positioned opposite each other. As a result, the foils adjacent to the space 510 will not bond anyhow. However, it is now possible to use a mechanical soft heater, which compresses all the layers in such a manner that the conductive layers make contact with each other and the other layers nevertheless experience pressure, causing them to bond. After said bonding of the foils, the resilient elements 505 cause the mass 500 to spring back to its original position. The MEMS accelerometer AC is provided with contact holes 530, 535 that function to provide access to the electrodes 502, 521. The upper electrode 502 is positioned partially on the foil 13 and partially on the foil 14. In this way the electrode 502 becomes accessible from the upper side for connection.

The operation of the MEMS accelerometer AC is as follows. When the accelerometer experiences an acceleration force perpendicular to the foils, the seismic mass 500 will move upwards or downwards, thereby changing the spacing between the electrodes 502, 521. Said change results in a change in the capacitance between said two electrodes, which latter change can be electrically detected.

FIG. 10 and FIG. 11 show a fourth embodiment of the microsystem according to the invention. These figures illustrate a possible implementation of a microvalve MV built up of a stack S of preprocessed foils. In FIG. 10, the foil stack S is already bonded, and FIG. 11 shows an expanded view of the microvalve MV. The microvalve MV is provided with a space 710 having an inlet 750 and an outlet 760. In this example, the outlet 760 is provided with a movable valve 770 in the form of a foil that is anchored at one side. Present on the movable valve 770 is an electrode in the form of a conductive layer 771. At the upper side of the space 710, a first electrode 701 is present in a foil 700 adjacent to said space 710. The first electrode is used for opening the valve 770. At the lower side of the space 710, a second electrode 722 is present in a foil 720 adjacent to said space 710.

The valve is a cantilever valve, as it is adjacent to the space 710, as a result of which it does not experience any pressure upon joining of the foils. The microvalve MV can be used with gases as well as with liquids. One might wonder in relation to FIG. 10 why the first three foils 1, 2, 3 bond. From FIG. 11 it becomes apparent, however, that only a small area adjacent to the space 710 is concerned. The area surrounding the space 710 will bond sufficiently, therefore. The microvalve MV is provided with contact holes 730, 735, 740 that function to provide access to the electrodes 701, 771, 722.

The microvalve MV operates as follows. When a voltage is applied between the contacts 730 (first electrode 701) and 740 (electrode 771), the valve will be electrostatically pulled towards the upper electrode 701, causing it to open. When a voltage is applied between the contacts 735 (second electrode 722) and 740 (electrode 771), the valve 770 will be electrostatically pulled towards the lower electrode 722, causing it to close.

FIG. 12 and FIG. 13 show a fifth embodiment of the microsystem according to the invention. The figures illustrate a possible implementation of a micropump MP built up of a stack S of preprocessed foils. In FIG. 12, the foil stack S is already bonded, and FIG. 13 shows an expanded view of the micropump MP. The micropump MV is provided with a first space 910 having an inlet 950 and an outlet 960. The first space 910 is provided with a passive valve 955 at the inlet 950 and a passive valve 965 at the outlet, which valves are so arranged that they only open to one side for passing a gas or a liquid. At the upper side, the first space 910 is provided with a movable membrane 900 in the form of a foil on which a first electrode 901 is present. At the bottom side, the first space 910 is provided with a second electrode 922, which is present at the bottom side of a foil 920 adjacent to the first space 910. Present above the membrane 900 is a second space 915, which is preferably fully closed. At the upper side of said second space, a third electrode 927 is present on a foil 925 adjacent to said second space 915. In FIG. 13, the electrode 927 is drawn at the upper side of the foil 4 for the sake of clarity, but in reality it is located at the bottom side. The micropump MP is provided with contact holes 930, 935, 940 that function to provide access to the electrodes 901, 922, 927.

The micropump MP operates as follows. When a voltage is applied between the third electrode 927 (via contact 940) and the first electrode 901 (via contact 930), the membrane will be electrostatically pulled towards the third electrode 927, causing the second space 915 to decrease in volume. As a result, the first space 910 will increase in volume, as a result of which an underpressure is generated in the first space 910. This causes the valve 955 at the inlet 950 of the space to open, and gas or liquid will be sucked into the space 910. When a voltage is applied between the second electrode 922 (via contact 935) and the first electrode 901 (via contact 930), the membrane 900 will be pulled towards the second electrode 922, causing the second space 915 to increase in volume and the first 910 to decrease in volume, as a result of which an overpressure is generated in the first space 910. This causes the valve 965 at the outlet 962 open, and gas or liquid will be expelled from the space 910. The second electrode 922 is optional. In the absence of a voltage on the third electrode 927, the membrane 900 will automatically return to the original position. The electrodes surrounding the second space 915 may also be arranged and used as resistors, enabling the second space 915 to expand via resistive heating.

In addition to micropumps and microvalves, also sensors can be formed in the microsystem according to the invention. This makes it possible to produce a so-termed μTAS element (micro total analysis system). FIG. 14 and FIG. 15 show this sixth embodiment of the microsystem according to the invention. The figures show a possible implementation of a μTAS element MT built up of a stack S of preprocessed foils. In FIG. 14, the foil stack S is already bonded, and FIG. 15 shows an expanded view of the μTAS element MT. The μTAS element MT is provided with a first space 1110 having an inlet 1150 and an outlet 1160. Two different sensors, viz. a flow sensor 1170 and a conductivity sensor 1180, are located adjacent to the space 1110 in this example. The sensors are present in the conductive layer on the foil that is adjacent to the space. In this example, the flow sensor 1170 comprises three series-connected resistive meander structures, one meander structure 1176 being used for heating and the other two meander structures 1172, 1174 being used for measuring the resistance of said meander structures, so that they are used as temperature sensors.

In this embodiment, a conductivity sensor 1180 is furthermore disposed adjacent to the space 1110. Said conductivity sensor 1180 comprises two comb structures 1182, 1184. In one embodiment, the impedance measured between the two comb structures 1182, 1184 is a measure of the amount of charged particles present in the space 1110, which, in a liquid, indicates the ion strength. The μTAS element MT is furthermore provided with contact holes 1130 that function to provide access to the electrodes of the sensors 1170, 1180.

In principle such flow sensors (a combination of a heating element 1174 and two temperature sensors 1172, 1174) and conductivity sensors 1180 are generally known, but they can be manufactured in a very simple manner by using the method according to the invention. If the μTAS element is used for liquids having a high pH value, the use of pure aluminum on the foils is not the best choice, because the aluminum is susceptible to attack. To make the sensors more inert, the sensors may be plated with, for example, copper (Cu), silver (Ag) or gold (Au). It is also possible to use a gold-plated tape from the outset.

FIG. 16 and FIG. 17 show another important advantage of the Microsystems according to the invention. The fact is that it is also possible to manufacture the microsystem according to the invention in such a manner that it also forms part of the package PA of an integrated circuit IC ( which may or may not be connected to the microsystem). FIG. 16 and FIG. 17 show by way of example a capacitive pressure sensor PS having an opening 1205 in the foil stack S. It is also possible to use a different microsystem, of course, for example an MEMS microphone. Present in the opening 1205 is the integrated circuit IC. In this example, the integrated circuit IC is connected to electrodes of the pressure sensor PS. The connections are formed by metal wires 1200 (e.g. gold or copper whilst) in FIG. 16 and by solder balls in FIG. 17. The second possibility is also referred to as flip-chip technology. Both in FIG. 16 and in FIG. 17 the microsystem PS is provided on a substrate 1300. However, it is also possible not to use a substrate 1300 but, for example, a much thicker foil stack S.

From the examples in the present disclosure it can be concluded that the invention can be used for manufacturing Microsystems such as MEMS devices and microfluidic devices in an inexpensive manner. The enumeration of embodiments is by no means exhaustive. The products obtained by using the present invention can be used both in consumer electronics and in medical applications in which cooperation between electronic devices and the environment is necessary. The cost of these products is even so low that they may be used as disposable products. A number of concrete applications of the invention are listed below:

MEMS microphones for mobile telephones and PDAs;

Micropumps and fluid treatment in chemical analysis systems; and

Pressure sensors in tires.

As regards the selection of the foil material, many materials may be used, for example polyvinyl chloride (PVC), polyimide (PI), Poly(ethylene terephthalate) (PET), poly(ethylene 2,6-naphthalate) (PEN), polystyrene (PS), polymethyl methacrylate (PMMA), polypropylene, polyethene, polyurethane (PU), cellophane, polyester, parilene. In fact it amounts to this that any material that meets a number of criteria may be used. Attention should be paid that:

the thickness of the foil determines the vertical resolution;

the foil, as the basic material, must be manageable, preferably supplied on a roll;

the foil is capable of being metallized;

the metallized foil is capable of being preprocessed, preferably by means of a laser;

the foil can be bonded after stacking, preferably by using heat and pressure;

the material can be melted at “low” temperatures (<300 degrees); and

the foil stack, after stacking and bonding, possesses the properties that are required for the microsystem.

An important note in this connection is that the bonding of the foils preferably takes place at a temperature just below the melting point of the foil material. For example, if polyethylene terephthalate (PET) is used as the foil material (having a melting point of 255° C.), a temperature of, for example, 220° C. will be used.

More in particular, the foil material must be selected on the basis of the properties required for the application in question, viz.: temperature stability, shape stability, pressure resistance, optical and chemical properties.

Finally, inorganic, insulating foils may be used, such as mica.

All the figures in the present description are merely schematic representations, which are moreover not drawn to scale. They are intended by way of illustration of the embodiments aimed at by the invention and to provide technical background. In reality, the shapes of boundary faces may differ from those of the boundary faces that are shown in the figures. In those places where the word “a(n)” is used, a number larger than one may be used, of course. It stands to reason that those skilled in the art will be able to devise new embodiments of the invention. Such new embodiments all fall within the scope of the claims, however.

Possible variations on the method according to the invention are the winding up of two foils at the same time. The foils may or may not come from two different rolls, for example. Furthermore, the foils may already be bonded. In addition, the foils may already be patterned. According to another variant, the foils do not have the same thickness. Furthermore, more than two foils may be wound up.

In the present description, the example of winding up a foil is extensively illustrated. It is also possible to stack separate foils, of course. In that situation it is also possible to stack foils that do not have the same thickness.

In addition, all the embodiments of the microsystem that have been described herein may comprise a number of foils different from the number mentioned herein. This depends in part on the designer's requirements.

1. A method of manufacturing a microsystem (MI, PS, AC, MV, MP, MT) provided with a space (110, 310, 510, 710, 910, 1110), comprising:
providing a set (S) of at least two electrically insulating flexible foils, wherein the individual foils comprise the same foil material, and wherein a conductive layer is present on at least one side of at least one foil, and wherein said conductive layer is suitable for use as an electrode or a conductor;
patterning the conductive layer so as to form an electrode or a conductor;
patterning at least one foil, in such a manner that an opening is formed, which opening forms the space of the microsystem;
stacking the set (S) of foils, thus forming the microsystem; and
joining the foils together, with the foils being bonded together at those positions where, when two adjacent foils are in contact with each other, at least one conductive layer between the foil material of two adjacent foils has been removed.

2. A method as claimed in claim 1, wherein the individual foils have substantially the same thickness.

3. A method as claimed in claim 1, wherein at least three electrically insulating flexible foils are provided.

4. A method as claimed in claim 1, wherein a movable element is formed of at least one foil in the microsystem, which movable element is attached to the microsystem on at least one side, wherein the movable element is selected from the group comprising a movable mass (500), a movable valve (770, 955, 965) and a movable membrane (100, 200, 300, 900), and wherein the movable element is present on one side of the space.

5. A method as claimed in claim 1, wherein the microsystem is provided with a sensor (1170, 1180) that is formed in a conductive layer on a foil near said space for measuring a quantity in said space.

6. A method as claimed in claim 1, wherein the microsystem to be manufactured comprises an MEMS device.

7. A method as claimed in claim 6, wherein the microsystem is selected from the group comprising an MEMS capacitor microphone (MI), an MEMS pressure sensor (PS), an MEMS accelerometer (AC).

8. A method as claimed in claim 1, wherein the microsystem comprises a microfluidic device.

9. A method as claimed in claim 7, wherein the microsystem is selected from the group comprising a microvalve (MV), a micropump (MP) and a μTAS element (MT).

10. A method as claimed in claim 1, wherein said patterning is carried out by a laser (L1, L2).

11. A method as claimed in claim 10, wherein said patterning is carried out by using one selected from:
leaving the conductive layer (11a) and the foil (10) in tact (A);
removing the conductive layer (11a) so as to expose the foil (10) (B);
removing the conductive layer (11a) and part of the foil (10), so that a thinner foil remains (C); and
completely removing the conductive layer (11a, 11b) and the foil so as to form the space (D).

12. A method as claimed in claim 1, wherein said stacking of the foils takes place by winding at least one foil (10) onto a first reel (70).

13. A method as claimed in claim 12, wherein the foil (10) is unwound from a second reel or roll (80) upon being wound onto the first reel (70).

14. A method as claimed in claim 13, wherein said patterning of the conductive layer (11a) and the foil (10) takes place at a position selected from on or near the first reel (L1), between the first and the second reel (L2), and on or near the second reel or roll (80).

15. A method as claimed in claim 1, characterized in that said joining of the foils is carried out by exerting a pressure on the stacked foils at an elevated temperature, with the pressure being exerted in a direction perpendicular to the foils.

16. A method as claimed in claim 15, wherein the pressure on the foils adjacent to the space in the structure is obtained through the application of an elevated pressure in said space.

17. A method as claimed in claim 1, wherein an opening (130, 135) is formed in the stack of foils so as to provide access from one side of the microsystem to a conductive layer (121) that is connected to an electrode of the microsystem.

18. A method as claimed in claim 1, wherein the microsystem is separated from the stack after fusion of the foils has taken place.

19. A method as claimed in claim 1, wherein the material for the conductive layer is selected from the group comprising aluminum, platinum, silver, gold, copper, indium tin oxide, and magnetic materials.

20. A method as claimed in claim 1, wherein the foil material is selected from the group comprising polyphenyl sulphide (PPS) and polyethylene terephthalate (PET).

21. A method as claimed in claim 1, wherein the foil (10) has a thickness between 1 μm and 5 μm.

22. A microsystem (MI, PS, AC, MV, MP, MT) built up of a set (S) of at least two electrically insulating flexible foils stacked one on top of the other, wherein the individual foils comprise the same foil material, wherein at least one foil is provided with a patterned conductive layer, which is arranged as an electrode, and wherein at least one foil is provided with a space (110, 310, 510, 710, 910, 1110).

23. A microsystem as claimed in claim 22, wherein the individual foils have substantially the same thickness.

24. A microsystem as claimed in claim 22, wherein the microsystem comprises at least three electrically insulating flexible foils.

25. A microsystem as claimed in claim 22, wherein the microsystem comprises a movable element, which movable element comprises at least one foil and which is attached to the microsystem on at least one side, wherein the movable element has been selected from the group comprising a movable mass (500), a movable valve (770, 955, 965) and a movable membrane (100, 200, 300, 900), and wherein the movable element present at one side of the space.

26. A microsystem as claimed in claim 22, wherein said microsystem comprises a sensor (1170, 1180) which is implemented in a conductive layer on a foil near the space for measuring a quantity in said space.

27. A microsystem as claimed in claim 25, wherein said microsystem comprises one of an MEMS capacitor microphone (MI), an MLMS pressure sensor (PS), an MES accelerometer (AC), a microvalve (V), and a micropump (MP).

28. A microsystem as claimed in claim 27, wherein the set (S) of foils comprises at least three foils, with a space (110) being present in the microsystem, which space (110) is provided on a first side thereof with a first foil (100) arranged as a membrane for receiving sound waves, and which space (110) is provided on a second side thereof with a second foil (120) arranged as a backplate, which second foil comprises an opening (125) for the passage of pressure waves to a free space, which space (110) has a thickness, measured in a direction perpendicular to the foils, of at least one foil, and wherein the membrane (100) and the backplate (120) are also provided with a conductive layer (102, 121), which layers (102, 121) lead to areas (130, 135) for electrically connecting the micro system.

29. A microsystem as claimed in claim 28, wherein the foil of the membrane (100) or the backplate (120) is provided with a conductive layer (101, 102, 121, 122) on two sides.

30. A microsystem as claimed in claim 28, wherein the foil of the membrane (200) comprises areas (208) at the edges thereof which are thinner than the rest of the foil of the membrane.

31. (canceled)

32. (canceled)

33. (canceled)

34. (canceled)

35. (canceled)

36. (canceled)

37. (canceled)

38. (canceled)

39. A microsystem as claimed in claim 38, further comprising another conductive layer (922) on the foil (920) on a second side of the first space (910), which conductive layer (922) defines a third electrode, wherein said first electrode (901) and said third electrode (922) overlap when projected on a plane parallel to the foils, so that the third electrode (922) can also be used for driving the movable foil (900) capacitively, wherein the conductive layer (922) of this electrode leads to an area (935) for electrically connecting the microsystem.

40. A microsystem as claimed in claim 26, wherein said microsystem comprises a μTAS element (MT).

41. A microsystem as claimed in claim 40, wherein the set (S) comprises at least three foils, with a channel (1110) having an inlet (1150) and an outlet (1160) for the passage of a gas or a liquid therethrough being present in the microsystem, wherein the channel (1110) has a thickness of at least one foil, measured in a direction perpendicular to the foils, and wherein the channel (1110) is provided with a sensor or actuator (1170, 1180) on one side

42. A microsystem as claimed in claim 41, wherein said sensor or actuator is formed in the conductive layer of the foil adjacent to the channel.

43. A microsystem as claimed in claim 42, further comprising a flow sensor (1170).

44. A microsystem as claimed in claim 42, characterized in that said microsystem comprises a conductivity sensor (1180).

45. A microsystem as claimed in claim 42, further comprising an additional sensor or actuator, which is present in a conductive layer of the foil adjacent to an opposite side of the channel (1110).

46. A microsystem as claimed in claim 22, wherein the material of the conductive layer comprises a metal from the group comprising aluminum, platinum, silver, gold, copper, indium tin oxide, and magnetic materials.

47. A microsystem as claimed in claim 22, wherein the material for the foils comprises a substance from the group comprising polyphenyl sulphide (PPS) and polyethylene terephthalate (PET).

48. A microsystem as claimed in claim 22, wherein the foil has a thickness between 1 μm and 5 μm.

49. A stack (S) of electrically insulating flexible foils comprising the microsystem as claimed in claim 27.

50. An electronic device comprising the microsystem as claimed in claim 27.

51. An electronic device as claimed in claim 50, wherein said electronic device further comprises an integrated circuit (IC) for reading or driving a signal from the microsystem.

52. An electronic device as claimed in claim 51, wherein the microsystem is provided with a recess (1205), in which the integrated circuit (IC) is accommodated, so that the microsystem forms a part of the package of the integrated circuit (IC), which integrated circuit (IC) is connected to the microsystem.

53. (canceled)
